(19) United States
(12) Patent Application Publication
(10) Pub. No.: US 2024/0169102 A1
(43) Pub. Date: May 23, 2024

(54) MODELING METHOD FOR COMPLEX TREE-LIKE OBJECTS

(71) Applicant: University of Electronic Science and Technology of China, Yangtze River Delta Research Institute, Huzhou City (CN)

(72) Inventors: Guan WANG, Huzhou City (CN); Ning XIE, Huzhou City (CN)

(21) Appl. No.: 18/374,542

(22) Filed: Sep. 28, 2023

(30) Foreign Application Priority Data
Nov. 21, 2022 (CN) 2022114698600

(51) Int. Cl. G06F 30/10

(52) U.S. Cl. CPC G06F 30/10; G06F 2111/10

(57) ABSTRACT

Provided herein is a modeling method for complex tree-like objects, which relates to the field of computer graphics. The method includes: calculating an average tree for a set of complex tree-like objects, constructing a probability distribution model for the set of complex tree-like objects, and generating the complex tree-like objects through random sampling or specific parameter constraints. It proposes a modeling method for complex tree-like objects, such as three-dimensional trees and human nervous systems. This allows complex tree-like objects to be synthesized either in a completely random manner or through specific parameter constraints, thereby solving the problem of high modeling complexity and the inability to effectively perform real-time modeling of complex tree-like objects in existing methods.

### CROSS-REFERENCE TO RELATED APPLICATIONS

This application claims priority under 35 U.S.C. § 119(a) to Chinese Patent Application No. 2022114698600, filed on Nov. 21, 2022, which is hereby incorporated by reference herein in its entirety.

### TECHNICAL FIELD

The present disclosure relates to the field of computer graphics, and more particularly, to a modeling method for complex tree-like objects.

### BACKGROUND

Currently, the task of data generation for tree-like objects (such as 3D tree models, neural systems, human vascular systems, etc.) is a significant research topic in the fields of computer graphics, computational biology, and medical data analysis. In the realm of computer graphics, the synthesis of 3D trees can enhance the realism of virtual environments, thereby improving the user experience and meeting the demands of industries such as film production and game development. In computational biology and medical applications, the mass synthesis of medical tree-like objects can serve as training data for relevant deep learning models, effectively facilitating case diagnosis and human health status analysis in downstream machine learning tasks. The shape of tree-like objects exhibits considerable variability in both geometry and topology, such as geometric deformations caused by curvature and stretching of branches, and topological differences resulting from variations in branch numbers. This makes the task of generating morphologically accurate complex tree-like objects challenging. Current mainstream methods for modeling tree-like objects rely on procedural techniques, such as L-systems, which require a high level of expertise from users, are time-consuming, and even minor syntax changes in L-systems can result in large variations in the generated models. These are not suitable for large-scale tree-like object synthesis. Some other methods generate tree-like objects from the perspective of data reconstruction, such as tree reconstruction based on images or 3D point clouds, but these often require high-quality images and are highly dependent on external data acquisition devices, like 3D scanners.

From another perspective, the work of model synthesis for tree-like objects can be based on a statistical probability distribution, i.e., learning the corresponding shape probability distribution from given tree-like object data. Synthetic tree-like objects can then be obtained through random sampling or parameter-constrained sampling methods. This approach features lightweight modeling, low requirements for domain-specific knowledge, and no dependency on external acquisition devices. It is suitable for constructing large-scale tree-like objects. At present, statistical model-based approaches are mainly applied to objects with fixed topological structures, such as human models, facial models, and artificial models (e.g., chairs, tables, etc.). Tree-like objects, due to their complex and variable topology, are not directly applicable to existing modeling methods.

In summary, the issues and drawbacks of existing technologies include:

High modeling complexity and an inability to effectively and efficiently model complex tree-like objects in real-time.

### SUMMARY

In view of the problems existing in the prior art, the present disclosure provides a modeling method for complex tree-like objects.

The present disclosure is implemented as follows, a modeling method for complex tree-like objects, which includes:
calculating an average tree for a set of complex tree-like objects, constructing a probability distribution model for the set of complex tree-like objects, and generating the complex tree-like objects through random sampling or specific parameter constraints.

Furthermore, the complex tree-like object is hierarchically constructed from tubular branches, each tubular branch β being described by a continuous skeleton curve, β: [0,1]→ [symbol] ³× [symbol] ⁺, parameterized skeleton curves are obtained by sampling along the skeleton curve, expressed as:

β=(f(s), r(s))=(x(s), y(s), z(s), r(s))
where x(s), y(s), z(s) are coordinate information of points on the skeleton curve, and r(s) is a corresponding radius of a branch at a respective point, with s being a parameter value sampled along the curve β, and s∈[0, 1];
a hierarchical representation of the complex tree-like object is β=(β⁰, {βⁱ, sⁱ}ᵢ₌₁ⁿ), β is stored in a hierarchical manner, composed of a main trunk and sub-trees, the sub-trees are composed of a main trunk and next-level sub-trees or side branches; where β⁰ represents the main trunk at the 0th level, {βⁱ, sⁱ}ᵢ₌₁ⁿ represents the sub-trees growing from a branching point β⁰(sⁱ); and if βⁱ contains a sub-tree, βⁱ is expressed as a main trunk with sub-trees until βⁱ contains no sub-tree.

Furthermore, the average tree is a tree-like object that minimizes the sum of Euclidean distances to all complex tree-like objects in the set βᵢ, expressed as:

$$μ = arg min {\sum }_{i = 1}^{m} d ( β , {β}_{i} )$$

a specific calculation method is as follows:
(1) setting μ=β₁;
(2) for i=1:m, finding a correspondence between βᵢ and μ using a linear assignment algorithm, thus minimizing a morphological difference between βᵢ and μ, including the addition of virtual branches;

$$μ = \frac{1}{m} {\sum }_{i = 1}^{m} {β}_{i} ; \qquad ( 3 )$$

(4) repeating steps (2) and (3) until reaching a predetermined number of iterations, such as 100, until the process ultimately converges; and
(5) returning the final μ as the average tree for the set of complex tree-like objects βᵢ.

Furthermore, a construction process for the average probability distribution model is:
translating centroids of the set of all aligned βᵢ to an origin, denoted as vᵢ=βᵢ−μ, calculating the corresponding covariance matrix

$$C = \frac{1}{m - 1} {\sum }_{i = 1}^{m} {v}_{i} {v}_{i}^{t} ,$$

where eigenvectors Λᵢ of C represent main morphological changes in the βᵢ set, and the eigenvalues λᵢ of C represent strength of changes along the main direction Λᵢ; and performing a multivariate Gaussian distribution fitting on βᵢ based on μ, Λᵢ, and λᵢ.

Furthermore, the process for generating complex tree-like objects through random sampling is:
randomly sampling a series of real numbers, a₁, a₂, . . . , aₖ˜ [symbol] (0, 1), where the eigenvectors corresponding to the first k eigenvalues satisfy

$$\frac{{\sum }_{i = 1}^{k} {λ}_{i}}{{\sum }_{i = 1}^{m} {λ}_{i}} > 0.99 ,$$

resulting in a new complex tree model as a linear combination of the first k eigenvectors, expressed as:

β=μ+Σᵢ₌₁^{k}aᵢ\sqrt{λᵢ}Λᵢ.

Furthermore, the process for generating complex tree-like objects through specific parameter constraints is a process of linear regression, including:
adding user constraints during the generation of complex trees, where p=[p₁, p₂, . . . , pₗ]∈ [symbol] ^{l} represents constraint parameters, and b=[b₁, b₂, . . . , b_{w}]∈ [symbol] ^{l} represents the vectorized expression of the complex tree β, then the mapping relationship between parameters p and vector b is expressed as:

M[p₁, p₂, . . . , pₗ, 1]^{T}=b
where the mapping matrix M=BP⁺, B represents the matrix expression of all b, and the matrix P⁺ is a pseudo-inverse matrix of P; and
the vectorized expression b is thus obtained, and the corresponding complex tree-like object β is retrieved through an inverse vectorization process.

Furthermore, the constraint parameters p is a height of the tree model, a length of lateral branches, as well as a cross-sectional deflection angle and a longitudinal-sectional deflection angle.

Another object of the present disclosure is to provide a modeling system for complex tree-like objects for implementing the modeling method for complex tree-like objects, comprising:
an average tree module for calculating an average tree for a set of complex tree-like objects;
a model construction module for constructing a probability distribution model for the set of complex tree-like objects; and
a complex tree generation module for generating the complex tree-like objects through random sampling or specific parameter constraints.

Another object of the present disclosure is to provide a computing device, wherein, the computing device comprises a memory and a processor, the memory stores a computer program, which when executed by the processor, causes the processor to carry out the steps of the modeling method for complex tree-like objects.

Another object of the present disclosure is to provide a computer-readable storage medium storing a computer program, which when executed by a processor, causes the processor to carry out the steps of the modeling method for complex tree-like objects.

Another object of the present disclosure is to provide an information data processing terminal, the information data processing terminal is utilized for implementing the modeling system for complex tree-like objects.

In conjunction with the above technical solution and the technical problems to be solved, the advantages and positive effects possessed by the technical solution to be protected by the present disclosure are as follows:

Firstly, in view of the technical problems existing in the prior art and the difficulty in solving these problems, a detailed and profound analysis is conducted closely related to the technical solution to be protected by the present disclosure, as well as the results and data obtained during the research and development process. Specifically, the present disclosure proposes a modeling method for complex tree-like objects, such as three-dimensional trees and human nervous systems. This allows complex tree-like objects to be synthesized either in a completely random manner or through specific parameter constraints, thereby solving the problem of high modeling complexity and the inability to effectively perform real-time modeling of complex tree-like objects in existing methods.

Secondly, considering the technical solution as a whole or from the perspective of the product, the technical effects and advantages possessed by the technical solution to be protected by the present disclosure are described as follows:

The present disclosure targets complex tree-like objects and proposes a simplified, lightweight, and scientifically-based modeling method. This allows users to generate a large number of similar tree-like objects based on a small amount of input data. The method has low requirements for users' professional knowledge and meets the practical needs of industries such as gaming, film, and healthcare.

Thirdly, as creative supplementary evidence for the claims of the present disclosure, the following important aspects are also reflected:

The technical solution of the present disclosure fills a technical gap in both Chinese and international industries:

Currently, in both Chinese and international industries, complex tree-like objects are generally modeled using L-system-based procedural modeling or image-based and three-dimensional point cloud-based modeling. These methods have high requirements for users' professional knowledge and high dependency on external data collection devices. In contrast, the present disclosure achieves simplified and lightweight modeling of complex tree-like objects from a statistical modeling perspective.

### BRIEF DESCRIPTION OF THE DRAWINGS

FIG. 1 is a schematic diagram illustrating the hierarchical representation of the complex tree-like object according to one or more embodiments of the present disclosure;

FIG. 2 is a schematic diagram illustrating the complex tree-like object according to one or more embodiments of the present disclosure, including (a) the input complex tree-like object, and (b) the complex tree-like object synthesized through random sampling.

### DETAILED DESCRIPTION

To make the objectives, technical solutions, and advantages of the present disclosure more clear and understandable, the disclosure will be further described in detail below with reference to embodiments. It should be understood that the specific embodiments described here are solely for the purpose of explaining the present disclosure and are not intended to limit the scope of the present disclosure.

In order to enable those skilled in the art to fully understand how the present disclosure is specifically implemented, this section provides an explanatory example that elaborates on the technical solution of the claims.

A modeling method for complex tree-like objects according to one or more embodiments of the present disclosure includes:
calculating the average tree corresponding to a set of complex tree-like objects, and subsequently constructing a probabilistic distribution model for the set of complex tree-like objects, generating complex trees either through random sampling or through specific parameter constraints.

The external morphology of a complex tree-like object can be considered as being hierarchically constructed from tubular branches. The shape of each tubular branch β can be described by a continuous skeleton curve, i.e., β: [0,1]→ [symbol] ³× [symbol] ⁺, and parameter sampling along the skeleton curve to obtain a parameterized skeleton curve, expressed as:

β=(f(s), r(s))=(x(s), y(s), z(s), r(s))

Where x(s), y(s), z(s) are the coordinate information of the points on the skeleton curve, and r(s) is the radius of the corresponding branch at the respective point; and s represents the parameter value sampled along the curve β, s∈[0, 1].

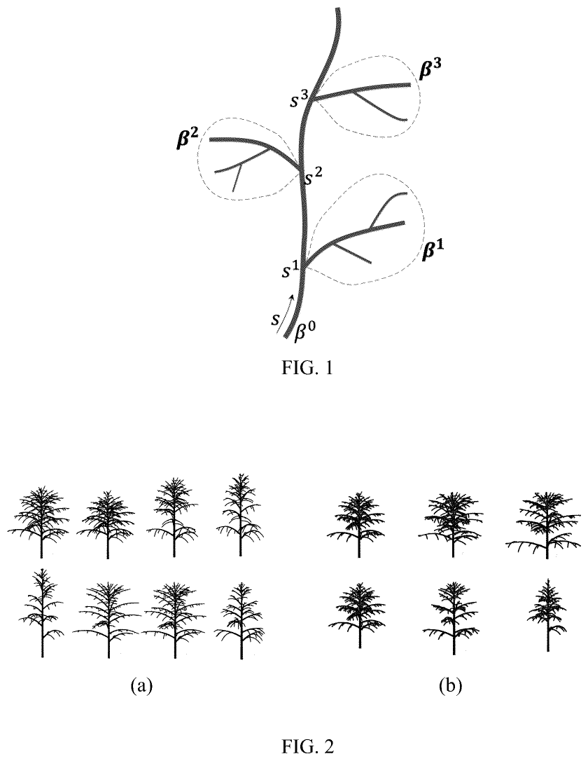

A complex tree-like object β can be hierarchically represented as β=(β⁰, {βⁱ, sⁱ}ᵢ₌₁ⁿ), β is stored in a hierarchical manner, where β⁰ represents a main trunk, i.e., the 0th level represents the main trunk; {βⁱ}ᵢ₌₁ⁿ represents the sub-trees growing out from the branching point β⁰ (sⁱ), as illustrated in FIG. 1. The complex tree-like object is iteratively represented based on the hierarchical information of the skeleton curve, consisting of a main trunk and sub-trees. Each sub-tree can be further composed of a main trunk and the next level of sub-trees or side branches. If βⁱ also contains sub-trees, βⁱ will continue to be represented iteratively in the same manner, βⁱ until does not contain any sub-trees.

Furthermore, the calculation process for the average tree is as follows:

For a given set of tree-like objects {βᵢ, i=1, 2, . . . , m}, the present disclosure first calculates the average tree corresponding to this set of complex trees. The average tree is morphologically the mean shape of the set of tree-like objects, and is defined mathematically as the tree that minimizes the sum of the distances to all complex trees βᵢ, mathematically defined as:

$$μ = arg min {\sum }_{\{ i = 1 \}}^{m} d ( β , {β}_{i} )$$

For facilitating a low computational overhead cost, the present disclosure adopts the Euclidean distance formula to calculate the distance between two complex trees, i.e., computing the Euclidean distances between corresponding branches, and then taking the sum of the distances between all corresponding branches as the morphological difference value between the two complex tree-like objects.

The specific calculation method for the average tree μ is as follows:
1) Set μ=β₁;
2) For i=1:m, finding the correspondence between βᵢ and μ to minimize the morphological difference between βᵢ and μ, which includes the addition of virtual branches, etc.;

$$μ = \frac{1}{m} {\sum }_{\{ i = 1 \}}^{m} {β}_{i} ;$$

4) Repeating steps 2) and 3) until convergence is achieved; and
5) Returning the final μ as the average tree for the set of complex tree-like objects βᵢ.

Further, the construction process for the probability distribution model is as follows:

After aligning all the tree models βᵢ with the average tree μ, at this point βᵢ can be considered as a set of elements in a high-dimensional space. The present disclosure constructs a probability distribution model for this set. First, the centroid of the set of aligned βᵢ is shifted to the origin, denoted as vᵢ=βᵢ−μ. The corresponding covariance matrix is calculated as

$$C = \frac{1}{m - 1} {\sum }_{i = 1}^{m} {v}_{i} {v}_{i}^{t} .$$

The eigenvectors Λᵢ of C describe the primary shape variations of the βᵢ set, and the corresponding eigenvalues λᵢ describe the strength of variation along the corresponding main direction Λᵢ. Based on μ, Λᵢ, and λᵢ, the present disclosure fits a multivariate Gaussian distribution to βᵢ.

Further, the specific process for generating complex tree objects through random sampling is as follows:

Initially, the present disclosure randomly samples several real numbers, a₁, a₂, . . . , aₖ˜ [symbol] (0, 1), where only the first k eigenvalues corresponding to eigenvectors are considered, and it satisfies

$$\frac{{\sum }_{i = 1}^{k} {λ}_{i}}{{\sum }_{i = 1}^{m} {λ}_{i}} > 0.99 .$$

A new complex tree model can be considered as the linear combination of the first k eigenvectors,
i.e., β=μ+Σᵢ₌₁^{k}aᵢ\sqrt{λᵢ}Λᵢ, and to ensure the rationality of the generated data, the present disclosure restricts the values of aᵢ within [−1, 1].

The specific process for generating complex trees through specific parameters constraints is as follows:

In the process of sample synthesis, the present disclosure adds some constraint factors, namely user constraints, for generating complex tree-like objects with specific attributes. This process can be considered as a linear regression process. Assuming p=[p₁, p₂, . . . , pₗ]∈ [symbol] ^{l} are user-defined constraint parameters, b=[b₁, b₂, . . . , b_{w}]∈ [symbol] ^{l} is the vectorized representation of the complex tree β, then the mapping relationship between parameter p and vector b can be expressed as:

M[p₁, p₂, . . . , pₗ, 1]^{T}=b

The mapping matrix can be calculated through M=BP⁺, where B is the matrix representation of all b, and P⁺ is the pseudoinverse matrix of P.

Through the above formulas, the vector representation b of the complex tree generated under the constraint of parameter p can be obtained.

Parameter p can be defined as certain biological parameters, such as for a tree model, p can be taken as the height of the tree model, the length of the lateral branches, as well as a cross-sectional deflection angle and a longitudinal-sectional deflection angle. After obtaining b, the corresponding complex tree β can be obtained through the inverse vectorization process.

To prove the creativity and technical value of the technical solution claimed in this disclosure, this part discusses its specific applications in products or related technologies.

The modeling of complex tree-like objects has numerous application fields. In computer graphics, the construction of a large number of 3D tree models can enhance the realism of virtual reality scenes, thereby providing a better user experience; and in computational medicine, constructing corresponding human neuronal system structures can provide data support for subsequent disease analysis and classification of neuronal system structures.

It should be noted that the embodiments of the present disclosure can be implemented through hardware, software, or a combination of both. The hardware portion can be realized using dedicated logic; the software portion can be stored in a memory and executed by an appropriate instruction execution system, such as a microprocessor or specially designed hardware. Those skilled in the art will understand that the aforementioned devices and methods can be implemented using computer-executable instructions and/or included in processor control code, for example, provided on media such as disks, CDs, or DVDs, programmable memory such as read-only memory (firmware), or data carriers such as optical or electronic signals. The devices and modules of the present disclosure can be implemented by hardware circuits such as very large-scale integration circuits or gate arrays, semiconductors such as logic chips and transistors, or programmable hardware devices such as field-programmable gate arrays, programmable logic devices, or can be implemented by software executed by various types of processors, or can be implemented by a combination of the aforementioned hardware circuits and software, such as firmware.

In the research and development or usage process, embodiments of the present disclosure have achieved some positive effects and indeed possess significant advantages compared to existing technology. The following content describes these aspects in conjunction with data and charts obtained from the experimental process. Part (a) of FIG. 2 shows the input of complex tree-shaped objects; and part (b) shows the complex tree-shaped objects synthesized by fitting a multi-variate Gaussian distribution followed by random sampling. Both sets of tree-shaped objects exhibit similarity in morphology, and the complex tree-shaped objects synthesized through random sampling also demonstrate reasonableness in morphology, indicating that the complex tree-shaped objects initially constructed by this modeling system meet the initial expectations and requirements.

The foregoing description is only specific embodiments of the present disclosure, but the scope of protection of the present disclosure is not limited thereto. Any modification, equivalent replacement, or improvement made within the spirit and principle of the present disclosure should fall within the scope of protection of the present disclosure.

What is claimed is:

1. A modeling method for complex tree-like objects, comprising:
calculating an average tree for a set of complex tree-like objects, constructing a probability distribution model for the set of complex tree-like objects, and generating the complex tree-like objects through random sampling or specific parameter constraints.

2. The modeling method for complex tree-like objects of claim 1, wherein, the complex tree-like object is hierarchically constructed from tubular branches, each tubular branch β being described by a continuous skeleton curve, β: [0,1]→ [symbol] ³× [symbol] ⁺, where [symbol] ³ represents a three-dimensional real number field, and [symbol] ⁺ represents an one-dimensional positive real number field, parameterized skeleton curves are obtained by sampling along the skeleton curve, expressed as:
β=(f(s), r(s))=(x(s), y(s), z(s), r(s))
where x(s), y(s), z(s) are coordinate information of points on the skeleton curve, and r(s) is a corresponding radius of a branch at a respective point, with s being a parameter value sampled along curve β, s∈[0, 1]; and
a hierarchical representation of the complex tree-like object is β=(β⁰, {βⁱ, sⁱ}ᵢ₌₁ⁿ), β is stored in a hierarchical manner, composed of a main trunk and sub-trees, the sub-trees are composed of a main trunk and next-level sub-trees or side branches; where β⁰ represents the main trunk at the 0th level, {βⁱ, sⁱ}ᵢ₌₁ⁿ represents the sub-trees growing from a branching point β⁰ (sⁱ); and if βⁱ contains a sub-tree, βⁱ is expressed as a main trunk with sub-trees until βⁱ contains no sub-trees.

3. The modeling method for complex tree-like objects of claim 1, wherein, the average tree is a tree-like object that minimizes the sum of Euclidean distances to all complex tree-like objects in the set βᵢ, mathematically expressed as:
$$μ = arg min {\sum }_{i = 1}^{m} d ( β , {β}_{i} )$$
a specific calculation method is as follows:
(1) setting μ=β₁;
(2) for i=1:m, addding virtual sub-trees to βᵢ or μ to make the number of sub-trees equal and finding a correspondence between the sub-trees of βᵢ and μ using a linear assignment algorithm, thus minimizing a total morphological difference between corresponding sub-trees of βᵢ and μ, wherein morphological difference values between sub-trees use the Euclidean distance;
(3) assigning the current mathematical mean of all βᵢ to μ, i.e.,
$$μ ← \frac{1}{m} {\sum }_{i = 1}^{m} {β}_{i} ;$$
(4) repeating steps (2) and (3) until reaching a predetermined number of iterations, such as 100; and
(5) returning the final μ as the average tree for the set of complex tree-like objects βᵢ.

4. The modeling method for complex tree-like objects of claim 1, wherein, a construction process for the average probability distribution model is:
translating centroids of the set of all aligned βᵢ to an origin, denoted as vᵢ=βᵢ−μ, calculating the corresponding covariance matrix
$$C = \frac{1}{m - 1} {\sum }_{i = 1}^{m} {v}_{i} {v}_{i}^{t} ,$$
where eigenvectors Λᵢ of C represent main morphological changes in the βᵢ set, and the eigenvalues λᵢ of C represent strength of changes along the main direction Λᵢ; and performing a multivariate Gaussian distribution fitting on βᵢ based on μ, Λᵢ, and λᵢ.

5. The modeling method for complex tree-like objects of claim 1, wherein, the process for generating complex tree-like objects through random sampling is:
randomly sampling a series of real numbers, a₁, a₂, . . . , aₖ˜ [symbol] (0, 1), where the eigenvectors corresponding to the first k eigenvalues satisfy
$$\frac{{\sum }_{i = 1}^{k} {λ}_{i}}{{\sum }_{i = 1}^{m} {λ}_{i}} > 0.99 ,$$
resulting in a new complex tree model as a linear combination of the first k eigenvectors, expressed as:
β=μ+Σᵢ₌₁^{k}aᵢ\sqrt{λᵢ}Λᵢ.

6. The modeling method for complex tree-like objects of claim 1, wherein, the process for generating complex tree-like objects through specific parameter constraints is a process of linear regression, including:
adding user constraints during the generation of complex trees, where p=[p₁, p₂, . . . , pₗ]∈ [symbol] ^{l} represents constraint parameters, and b=[b₁, b₂, . . . , b_{w}]∈ [symbol] ^{l} represents the vectorized expression of the complex tree β, then the mapping relationship between parameters p and vector b is expressed as:
M[p₁, p₂, . . . pₗ, 1]^{T}=b
where the mapping matrix M=BP⁺, B represents the matrix expression of all b, P represents the matrix expression of all p, and P⁺ is a pseudo-inverse matrix of P; and
the vectorized expression b is thus obtained, and the corresponding complex tree-like object β is retrieved through an inverse vectorization process.

7. The modeling method for complex tree-like objects of claim 6, wherein, the constraint parameters p represents a height of the tree model, a length of lateral branches, as well as a cross-sectional deflection angle and a longitudinal-sectional deflection angle.

8. A modeling system for complex tree-like objects for implementing the modeling method for complex tree-like objects of claim, comprising:
an average tree module for calculating an average tree for a set of complex tree-like objects;
a model construction module for constructing a probability distribution model for the set of complex tree-like objects; and
a complex tree generation module for generating the complex tree-like objects through random sampling or specific parameter constraint.

9. A computing device, wherein, the computing device comprises a memory and a processor, the memory stores a computer program, which when executed by the processor, causes the processor to carry out the steps of the modeling method for complex tree-like objects of claim 1.

10. A computer-readable storage medium storing a computer program, which when executed by a processor, causes the processor to carry out the steps of the modeling method for complex tree-like objects of claim 1.
